(19) United States
(12) Patent Application Publication
(10) Pub. No.: US 2006/0137818 A1
(43) Pub. Date: Jun. 29, 2006

(54) Laminating apparatus and method

(75) Inventor: Akira Mizuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/315,144

(22) Filed: Dec. 23, 2005

(30) Foreign Application Priority Data
Dec. 24, 2004 (JP) P.2004-374748

(51) Int. Cl. B32B 37/00

(52) U.S. Cl. 156/312; 156/358; 156/580

(57) ABSTRACT

A laminating apparatus for laminating a cover layer onto a disk substrate, including a pressure member for pressing a surface of the disk substrate opposite to a surface on which the cover layer will be laminated, wherein: the pressure member includes a first pressure portion for pressing an outer circumferential end portion of the disk substrate, and a second pressure portion for pressing an inner circumferential end portion of the disk substrate; and after the first pressure portion presses the outer circumferential end portion of the disk substrate, the second pressure portion presses the inner circumferential end portion of the disk substrate to thereby laminate the cover layer onto the disk substrate.

### FIELD OF THE INVENTION

The present invention relates to a laminating apparatus and method. Particularly, it relates to a laminating apparatus and method for laminating a cover sheet onto a disk substrate and it relates to an optical disk producer.

### BACKGROUND OF THE INVENTION

Optical disks such as CD (compact disc), CD-R (compact disc-recordable), DVD (digital versatile disc), DVD-R (digital versatile disc-recordable), etc. have heretofore come into wide use.

Examination of high-density information recording in an optical disk has advanced in recent years in accordance with the demand for storage of a larger quantity of information such as video information. The information recording density of the optical disk chiefly depends on the size of a light beam spot on the disk. The spot size is proportional to λ/NA in which λ is the wavelength of the laser beam, and NA is the numerical aperture of an objective lens. For this reason, increase in NA of the objective lens is effective while reduction in wavelength of the laser beam is required for increasing the recording density of the optical disk. Because coma aberration caused by inclination of the optical disk is in proportion to the cube of the NA, the margin for the inclination due to tilting, etc. of the disk however becomes very small in accordance with increase in the NA. Even when the disk is inclined slightly, the beam spot is blurred so that it is impossible to record and reproduce information with high density. Therefore, in a background-art optical disk suitable for higher density recording, a sufficiently thin (e.g. about 0.1 mm thick) cover layer is provided on a disk substrate so that the cover layer serves as a laser beam-transmissive layer in order to suppress increase of the coma aberration caused by inclination of the disk with increase in the NA.

In a line for production of such an optical disk, there is performed a process for laminating a light-transmissive cover layer of a thin film-like resin onto a recording surface of a disk substrate in which a recording surface has been formed, for example, as disclosed in JP-A-2-128335.

FIG. 12 is a view for explaining a state where a cover layer is to be laminated onto a disk substrate.

As shown in FIG. 12, a cover layer 103 is disposed on a support portion 105 formed on an upper surface of a support stage 104 which is disposed on a turntable not shown. On this occasion, the cover layer 103 is disposed in such a manner that a center pin 106 formed to protrude upward from the support portion 105 is inserted into a hole of a center portion of the cover layer 103 while a tacky film formed as a single surface of the cover layer 103 is turned upward. Then, a disk substrate 102 in which a recording layer has been formed is conveyed above the cover layer 103 disposed on the support stage 104, by a not-shown arm or the like, and the center pin 106 is inserted into a center hole of the disk substrate 102. On this occasion, the center hole of the disk substrate 102 is stopped at a diameter-reduced front end portion of the center pin 106 because the center hole of the disk substrate 102 is smaller in diameter than the hole of the cover layer 103, so that the disk substrate 102 is held in the condition that the recording layer is turned toward the cover layer 103 side. The disk substrate 102 is then conveyed in the condition that the disk substrate 102 is kept separate from the cover layer 103 while the center axis S of the disk substrate 102 coincides with the center axis of the cover layer 103.

In the laminating apparatus, the cover layer 103 and the disk substrate 102 held by the support stage 104 in the aforementioned manner are moved into a vacuum tank. In a vacuum atmosphere in the vacuum tank, the center pin 106 is moved down so that the disk substrate 102 is brought into contact with the tacky film of the upper surface of the cover layer 103. As a result, the disk substrate 102 is laminated on the cover layer 103, so that an optical disk 101 is produced.

### SUMMARY OF THE INVENTION

Incidentally, for laminating the disk substrate on the cover layer, the disk substrate is pressed against the cover layer held on the support stage. For this reason, a radial warp (which means deformation in directions of arrows R in FIG. 12 and which is hereinafter referred to as “R-tilt”) occurs in the disk substrate. In this respect, there is still room for improvement.

Although JP-A-2-128335 has described such a measure that force for pressing outer and inner circumferential portions of the disk substrate is set to be stronger than force for pressing an information-recorded portion of the disk substrate, the problem of the R-tilt of the disk substrate 102 cannot be solved by the measure.

An object of the invention is to provide a laminating apparatus and method which can restrain a disk substrate from being deformed when the disk substrate is laminated on a cover layer.

The present inventor has found that the foregoing object can be achieved by the following invention:

(1) A laminating apparatus for laminating a cover layer onto a disk substrate, including a pressure member for pressing a surface of the disk substrate opposite to a surface on which the cover layer will be laminated, wherein: the pressure member includes a first pressure portion for pressing an outer circumferential end portion of the disk substrate, and a second pressure portion for pressing an inner circumferential end portion of the disk substrate; and after the first pressure portion presses the outer circumferential end portion of the disk substrate, the second pressure portion presses the inner circumferential end portion of the disk substrate to thereby laminate the cover layer onto the disk substrate.

(2) A laminating apparatus according to the paragraph (1), wherein the second pressure portion presses the inner circumferential end portion after the first pressure portion presses the outer circumferential end portion in a place at least 0.1 mm ahead from the second pressure portion.

(3) A laminating method for laminating a cover layer onto a disk substrate, including the steps of: operating a first pressure means to press an outer circumferential end portion of the disk substrate; and then operating a second pressure means to press an inner circumferential end portion of the disk substrate so that a surface of the disk substrate opposite to a surface on which the cover layer will be laminated is pressed to thereby laminate the cover layer onto the disk substrate.

(4) A lamination method according to the paragraph (3), wherein the second pressure means presses the inner circumferential end portion after the first pressure means presses the outer circumferential end portion in a place at least 0.1 mm ahead from the second pressure means.

According to the invention, it is possible to provide a laminating apparatus and method which can restrain a disk substrate from being deformed when the disk substrate is laminated on a cover layer.

### BRIEF DESCRIPTION OF. THE DRAWINGS

FIG. 1 is a view, partly in enlarged section, showing an optical disk produced by an optical disk laminating apparatus and method according to an embodiment of the invention.

FIG. 2 is a view showing the optical disk laminating apparatus according to the embodiment of the invention.

FIG. 3 is a view for explaining important part of the laminating apparatus depicted in FIG. 2.

FIG. 4 is a view showing a state where a first pressure portion is pressing a disk substrate.

FIG. 5 is a view showing a state where both the first pressure portion and a second pressure portion are pressing the disk substrate when a pressure member depicted in FIG. 4 is further moved down.

FIG. 6 is a graph showing changes in maximum and minimum R-tilt values before and after lamination in Example 1.

FIGS. 7A to 7C are graphs showing changes in maximum and minimum R-tilt values before and after lamination in Comparative Examples 1-1 to 1-3.

FIG. 8 is a graph showing average R-tilt variations in Examples 3 to 5 and Comparative Example 2.

FIG. 9 is a graph showing average R-tilt variations in Examples 6 to 8 and Comparative Example 3.

FIG. 10 is a view showing a modified example of the laminating apparatus according to the invention.

FIG. 11 is a view showing another modified example of the laminating apparatus according to the invention.

FIG. 12 is a view for explaining a state where a cover layer is to be laminated onto a disk substrate.

### DESCRIPTION OF REFERENCE NUMERALS:

1 optical disk
2 disk substrate
3 cover layer
4 recording layer
10 optical disk laminating apparatus
20 pressure member
22 second pressure portion
24 first pressure portion

### DETAILED DESCRIPTION OF THE INVENTION

An embodiment of the invention will be described below in detail with reference to the drawings.

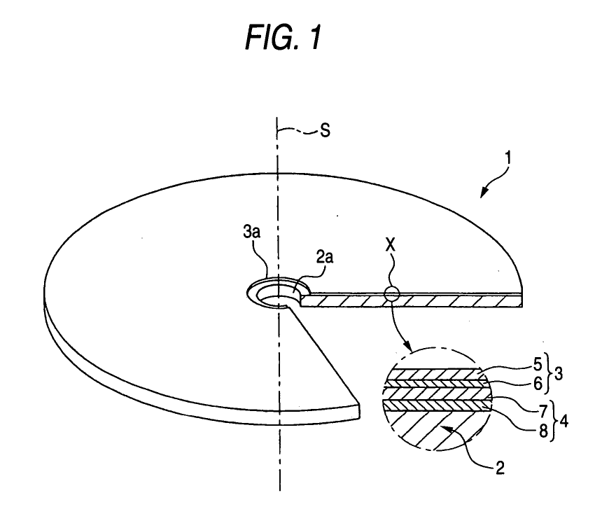

FIG. 1 is a view, partly in enlarged section, showing an optical disk produced by an optical disk laminating apparatus and method according to the following embodiment.

The optical disk 1 permits information recording with higher density than a background-art DVD. When, for example, the numerical aperture NA of an objective lens of a disk drive device is increased to about 0.85 while a blue-violet laser beam with a short wavelength is used as a recording/reproducing laser beam, the single-side recording capacity of the optical disk 1 with a diameter of 12 cm can be increased to about 27 gigabytes compared with an optical disk according to the background art.

The optical disk 1 has a disk substrate 2 shaped like a discus. As shown in the enlarged section of a portion X in FIG. 1, an information recording layer 4 and a cover layer 3 are laminated successively on a single surface of the disk substrate 2 so that the recording layer 4 is covered with the cover layer 3.

The recording layer 4 is formed in such a manner that a light reflecting layer 8 and a light absorbing layer 7 are laminated successively on the disk substrate 2. The cover layer 3 has a resin film 5, and a tacky film 6 formed on a single surface of the resin film 5. The cover layer 3 serves as a light-transmissive protective layer.

The disk substrate 2 is molded out of a resin such as polycarbonate. For example, the resin film 5 of the cover layer 3 is made of polycarbonate, photo-setting acrylic resin (such as ultraviolet-setting acrylic resin), TAC, PMMA or the like whereas the tacky film 6 of the cover layer 3 is made of a tackifier such as an acrylic tackifier, a rubber tackifier or a silicon tackifier. Especially, the acrylic tackifier is preferably used as the material of the tacky film 6 in terms of transparency and durability.

In this embodiment, the thickness of the cover layer 3 in the optical disk 1 can be set to be in a range of from 95 μm to 105 μm. The thickness of the resin film 5 can be set to be in a range of from 10 μm to 100 μm. The thickness of the tacky film 6 can be set to be in a range of from 5 μm to 30 μm.

A center hole 2a, which is shaped like a circle with a center axis S of rotation of the optical disk 1 as its center, is provided in the central portion of the disk substrate 2. A hole 3a, which is shaped like a circle with the axis S as its center and with a diameter larger than the diameter of the center hole 2a, is formed in the central portion of the cover layer 3.

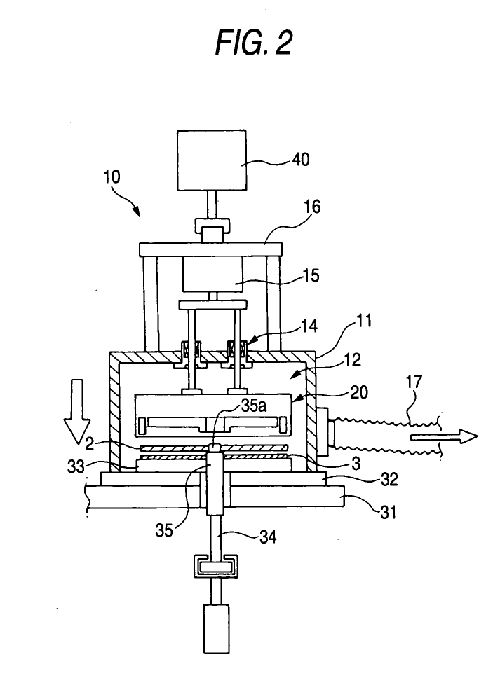

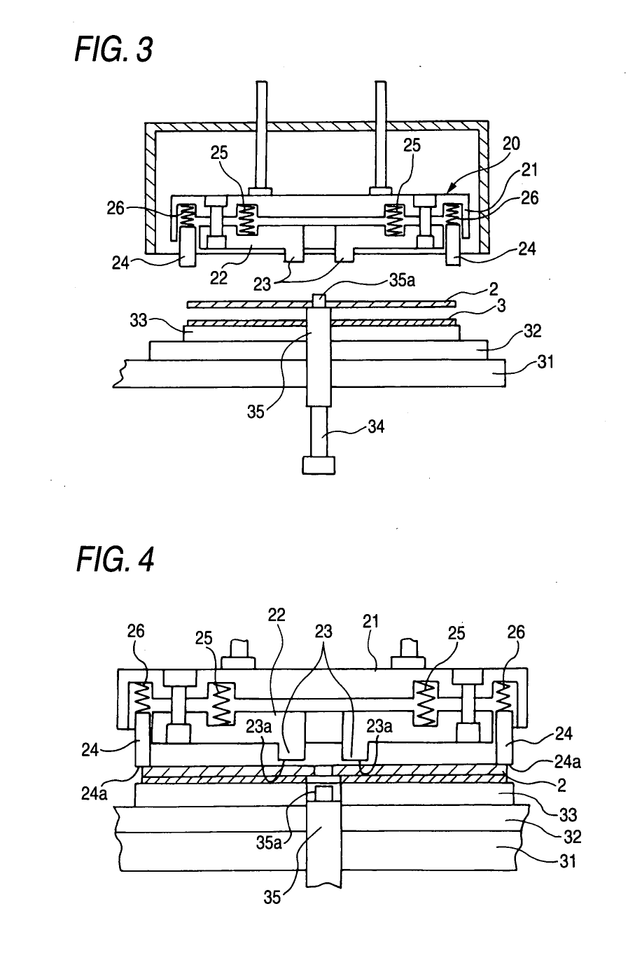

FIG. 2 is a view showing an optical disk laminating apparatus according to the embodiment. FIG. 3 is a view for explaining important part of the laminating apparatus depicted in FIG. 2.

Before lamination is performed in a process of producing the optical disk 1, a cover layer 3 is disposed on a support portion 33 of a support stage 32 on a turntable 31 provided in a production line. On this occasion, a center pin 35 is inserted into the hole of the cover layer 3 so that the cover layer 3 is held while the tacky film 6 (see FIG. 1) of the cover layer 3 is turned upward. In addition, a disk substrate 2 is held in a front end portion 35a of the center pin 35 in the condition that the disk substrate 2 is kept substantially parallel to the cover layer 3 and separate from the cover layer 3 while the recording layer 4 of the disk substrate 2 is turned downward. In this condition, the turntable 31 is rotated so that the support stage 32 supporting the disk substrate 2 and the cover layer 3 is conveyed to a position where a laminating process will be carried out by a laminating apparatus 10.

The laminating apparatus 10 includes a body frame 16, a linear actuator 15 retained by the body frame 16, a drive rod portion 14 linked to the linear actuator 15, and a pressure member 20 fixed to a lower end portion of the drive rod portion 14.

The laminating apparatus 10 further includes a vacuum tank 11 provided under the body frame 16. The vacuum tank 11 is a container-like member which has an upper end surface fixed to the body frame 16, and a lower end surface opened.

In the laminating process, the vacuum tank 11 is moved down by an actuator 40 provided above the vacuum tank 11, so that a lower end surface of the vacuum tank 11 is brought into contact with an upper surface of a support stage 32 by strong pressure. At the same time, air is removed from the inside of the vacuum tank 11 through an exhaust pipe 17 connected to the vacuum tank 11. In this manner, an internal space 12 of the vacuum tank 11 is kept in a vacuum environment. When the disk substrate 2 is laminated on the cover layer 3 in the aforementioned vacuum environment, air can be restrained from entering in between the disk substrate 2 and the cover layer 3 laminated to each other.

The laminating apparatus 10 carries out the laminating process as follows. That is, when the linear actuator 15 is controlled to actuate the drive rod portion 14 to move up and down in FIG. 2, the pressure member 20 can be moved up and down. In a position where the pressure member 20 is moved up, the pressure member 20 is separated from the disk substrate 2 supported by the support stage 32. In a position where the pressure member 20 is moved down, the pressure member 20 is brought into contact with the disk substrate 2 to thereby press the disk substrate 2 downward.

As shown in FIG. 3, the pressure member 20 is roughly shaped like a discus having a predetermined thickness. Specifically, the pressure member 20 has a fixation member 21, a ring-like first pressure portion 24 (first pressure means), and a discus-shaped second pressure portion 22 (second pressure means). The fixation member 21 is shaped like a circular plate in view from the disk substrate 2 side. The first pressure member 24 is attached along an outer circumferential end portion of a lower surface of the circular pressure portion 22. The second pressure portion 22 is attached to a lower surface of the fixation member 21 with interposition of urging members 25 such as coil springs. The first pressure portion 24 is attached to the outer circumferential end portion of the lower surface of the fixation member 21 through urging members 26 such as coil springs disposed substantially at circumferentially regular intervals. Here, the first pressure portion 24 and the second pressure portion 22 are disposed in the fixation member 21 so as to be concentric with the center axis of the disk substrate 2.

The second pressure portion 22 is formed so that the area of a pressure-side circular pressure surface of the second pressure portion 22 is smaller than that of the disk substrate 2. The first pressure portion 24 is formed so that the inner diameter of the first pressure portion 24 is larger than the diameter of the pressure surface of the second pressure portion 22. In this embodiment, the diameter of a pressure surface of the first pressure portion 24 is formed to be in a range of from 110 mm to 120 mm whereas the diameter of the pressure surface of the second pressure portion 22 is formed to be in a range of from 16 mm to 106 mm.

A ring-like protrusion portion 23 is formed on an inner circumferential edge portion of the pressure surface of the second pressure portion 22 so that the protrusion portion 23 has a predetermined radial size and a large thickness. The protrusion portion 23 is formed so that the diameter of the lower end portion of the protrusion portion 23 is in a range from 16 mm to 28 mm.

When the pressure member 20 is moved down in the laminating process in the laminating apparatus 10 according to the embodiment, the first pressure portion 24 first presses an outer circumferential end portion of an upper surface of the disk substrate. When the pressure member 20 is further moved down, the protrusion portion 23 of the second pressure portion 22 presses another portion than the outer circumferential end portion of the upper surface of the disk substrate 2.

Next, a state where the disk substrate 2 is pressed by the pressure member 20 will be described with reference to the drawings.

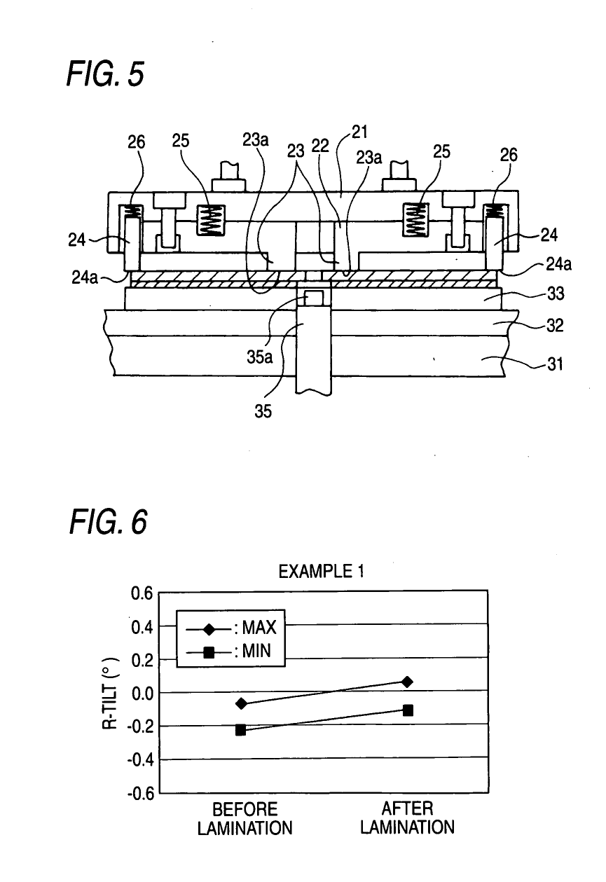

FIG. 4 is a view showing a state where the first pressure portion is pressing the disk substrate. FIG. 5 is a view showing a state where both the first and second pressure portions are pressing the disk substrate after the pressure member depicted in FIG. 4 is further moved down.

As shown in FIG. 4, in the laminating process, the pressure member 20 is moved down so that a lower end surface 24a of the first pressure portion 24 is brought into contact with an outer end portion of the disk substrate 2. On this occasion, the urging members 26 for supporting the first pressure portion 24 contract between the first pressure portion 24 and the fixation member 21 to thereby generate urging force in the first pressure portion 24. As a result, the first pressure portion 24 presses the outer end portion of the disk substrate 2 with predetermined bearing pressure.

The range in which the outer end portion of the disk substrate 2 is to be pressed is set to be all or part of a region extending from 100 mm to 120 mm radially far from the center axis of the disk substrate 2.

When the pressure member 20 begins to be moved down as shown in FIG. 4, the first pressure portion 24 applies predetermined bearing pressure on the disk substrate 2 after the first pressure portion 24 comes into contact with the substrate disk 2. In this condition, the second pressure portion 22 is still separate from the disk substrate 2. This is because the lower end surface 24a of the first pressure portion 24 is formed to protrude downward from the lower end surface 23a of the protrusion portion 23 of the second pressure portion 22 in the condition that the pressure member 20 is moved down. In this embodiment, the lower end surface 24a of the first pressure portion 24 is formed to protrude downward preferably by 0.1 to 5 mm, more preferably by 0.5 to 2.0 mm from the lower end surface 23a of the protrusion portion 23 of the second pressure portion 22.

When the pressure member 20 is further moved down in the condition that the first pressure portion 24 is pressing the disk substrate 2, the lower end surface 23a of the protrusion portion 23 of the second pressure portion 22 comes into contact with the inner circumferential end portion of the upper surface of the disk substrate 2 as shown in FIG. 5. Since the urging members 25 provided between the second pressure portion 22 and the fixation member 21 contract in accordance with the descend of the pressure member 20, elastic repulsion force is generated downward in the second pressure portion 22 to thereby press the inner circumferential end portion of the disk substrate 2.

The range in which the inner circumferential end portion of the disk substrate 2 is to be pressed is set to be all or part of a region extending from 15 mm to 40 mm radially far from the center axis of the disk substrate 2.

Here, at the time of lamination, the bearing pressure applied on the outer circumferential end portion of the disk substrate 2 is preferably set to be in a range of from 3 kPa to 100 kPa whereas the bearing pressure applied on the inner circumferential end portion of the disk substrate 2 is preferably set to be in a range of from 100 kPa to 500 kPa. In addition, it is preferable that the bearing pressure on the inner circumferential end portion is set to be higher than the bearing pressure on the outer circumferential end portion.

### FIRST EMBODIMENT

In order to prove an effect in the case where a laminating apparatus and method according to the invention were used, measurement was performed as described in the following Example 1 and Comparative Examples 1. In the following examples, assume that a laminating process is performed in the basically same procedure as that in the aforementioned embodiment, and that the configuration of each laminating apparatus will be described with proper reference to the laminating apparatus according to the aforementioned embodiment. Difference from the aforementioned embodiment will be described in accordance with necessity.

In Example 1 and Comparative Examples 1, the cover layer 3 and the disk substrate 2 supported by the support stage 32 were disposed in the inside of the vacuum tank 11 set in the vacuum environment as shown in FIG. 2. After the common procedure of moving down the pressure member 20 to press the disk substrate 2 to thereby laminate the disk substrate 2 onto the cover layer 3 located below the disk substrate 2, the laminating process was preformed in each of the following procedures.

In Example 1, after the first pressure portion 24 pressed the outer circumferential end portion of the upper surface of the disk substrate 2 with bearing pressure of 8 kPa, the second pressure portion 22 pressed the inner circumferential end portion of the upper surface of the disk substrate 2 with bearing pressure of 280 kPa in the same manner as in the aforementioned embodiment to thereby laminate the disk substrate 2 onto the cover layer 3. FIG. 6 is a graph showing changes in maximum and minimum R-tilt values before and after the lamination in Example 1.

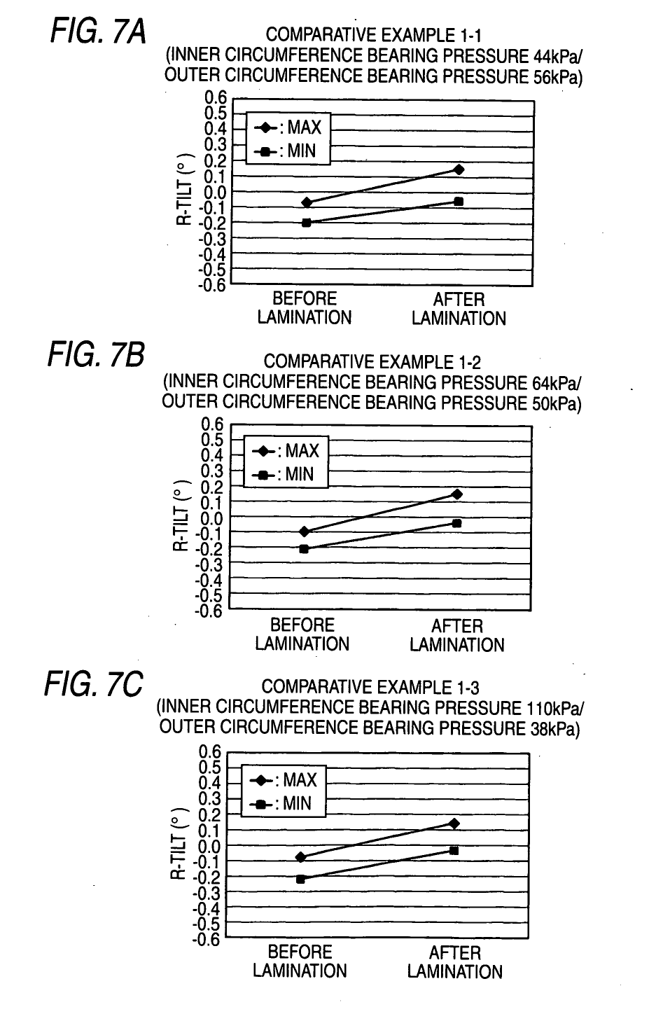

In each of Comparative Examples 1, the disk substrate 2 was laminated onto the cover layer 3 as follows. In Comparative Example 1-1, after the second pressure portion 22 pressed the inner circumferential end portion of the upper surface of the disk substrate 2 with bearing pressure of 44 kPa, the first pressure portion 24 pressed the outer circumferential end portion of the upper surface of the disk substrate 2 with bearing pressure of 56 kPa to thereby laminate the disk substrate 2 onto the cover layer 3. In Comparative Example 1-2, after the second pressure portion 22 pressed the inner circumferential end portion of the upper surface of the disk substrate 2 with bearing pressure of 64 kPa, the first pressure portion 24 pressed the outer circumferential end portion of the upper surface of the disk substrate 2 with bearing pressure of 50 kPa to thereby laminate the disk substrate 2 onto the cover layer 3. In Comparative Example 1-3, after the second pressure portion 22 pressed the inner circumferential end portion of the upper surface of the disk substrate 2 with bearing pressure of 110 kPa, the first pressure portion 24 pressed the outer circumferential end portion of the upper surface of the disk substrate 2 with bearing pressure of 38 kPa to thereby laminate the disk substrate 2 onto the cover layer 3. FIGS. 7A to 7C are graphs showing changes in maximum and minimum R-tilt values before and after the lamination in Comparative Examples 1.

When the second pressure portion 22 pressed the inner circumferential end portion of the disk substrate 2 after the first pressure portion 24 pressed the outer circumferential end portion of the disk substrate 2 as represented by Example 1 shown in FIG. 6, changes in the R-tilt as a radial warp of the disk substrate before and after the lamination could be suppressed. On the other hand, when the first pressure portion 24 pressed the outer circumferential end portion of the disk substrate 2 after the second pressure portion 22 pressed the inner circumferential end portion of the disk substrate 2 as represented by each of Comparative Examples 1 shown in FIGS. 7A to 7C, changes in the R-tilt as a radial warp of the disk substrate before and after the lamination became larger than those in Example 1.

When a difference between an average of maximum R-tilt values and an average of minimum R-tilt values before and after the lamination in each of Example 1 and Comparative Examples 1 was regarded as an average R-tilt variation, the average R-tilt variation in Example 1 could be reduced approximately to a half compared with the average R-tilt variation in each of Comparative Examples 1.

### SECOND EMBODIMENT

In order to prove an effect in the case where a laminating apparatus and method according to the invention were used, measurement was performed as described in the following Examples 2 to 5 and Comparative Example 2.

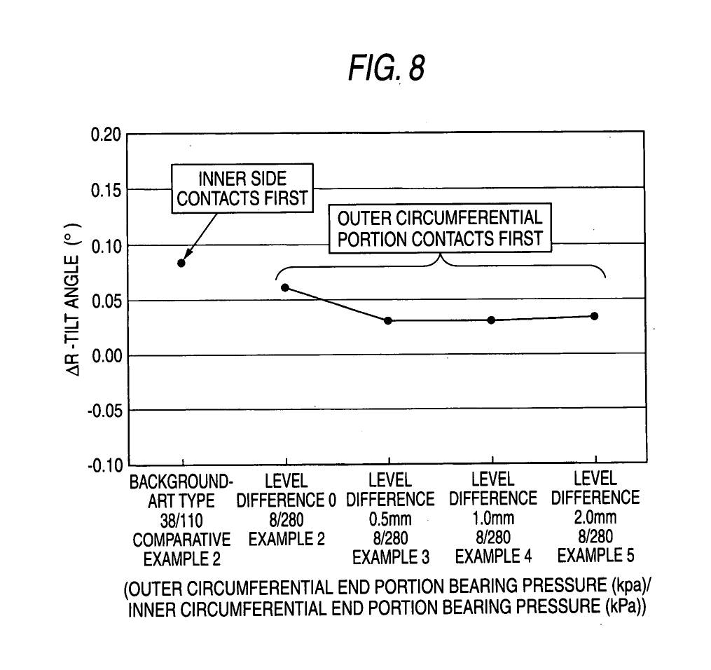

In Example 2, for lamination in the case where the pressure member 20 was not moved down (i.e. both the first and second pressure portions 24 and 22 were separate from the disk substrate 2) so that the lower end surface 24a of the first pressure portion 24 almost did not protrude downward from the lower end surface 23a of the protrusion portion 23 of the second pressure portion 22 (i.e. the difference in level between the lower end surfaces 24a and 23a was in a range of from 0 mm to 0.1 mm), the inner circumferential end portion of the disk substrate 2 was pressed by the protrusion portion 23 of the second pressure portion 22 substantially at the same time that the outer circumferential end portion of the disk substrate 2 was pressed by the first pressure portion 24. FIG. 8 shows an average R-tilt variation in Example 2.

In Example 3, for lamination in the case where the pressure member 20 was not moved down so that the lower end surface 24a of the first pressure portion 24 was protruded downward by a level difference of about 0.5 mm (0.5±0.1 mm) from the lower end surface 23a of the protrusion portion 23 of the second pressure portion 22, the outer circumferential end portion of the disk substrate 2 was first pressed by the first pressure portion 24 and the inner circumferential end portion of the disk substrate 2 was then pressed by the second pressure portion 22. FIG. 8 also shows an average R-tilt variation in Example 3. Similarly, the level difference was set at 1.0 mm (or 1.0 mm±0.1 mm) in Example 4 and at 2.0 mm (or 2.0 mm±0.1 mm) in Example 5. In each of Examples 4 and 5, the first and second pressure portions 24 and 22 pressed the disk substrate 2 in the same procedure as that in Example 3. FIG. 8 further shows an average R-tilt variation in each of Examples 4 and 5.

In Comparative Example 2, for lamination, the second pressure portion 22 pressed the inner circumferential end portion of the disk substrate 2 with bearing pressure of 110 kPa and then the first pressure portion 24 pressed the outer circumferential end portion of the disk substrate 2 with bearing pressure of 38 kPa. FIG. 8 further shows an average R-tilt variation in Comparative Example 2.

As shown in FIG. 8, it is apparent that the average R-tilt variation in each of Examples 3 to 5 can be reduced to be not larger than 0.05° when the outer circumferential end portion of the disk substrate 2 was first pressed and the inner circumferential end portion of the disk substrate 2 was then pressed in the condition that the level difference was set to be in a range of from 0.5 mm to 2 mm. It is also apparent that the average R-tilt variation in Example 2 can be reduced to a value not so small as that in each of Examples 3 to 5 when the outer circumferential end portion of the disk substrate 2 was first pressed and the inner circumferential end portion of the disk substrate 2 was then pressed in the condition that the level difference was set to be in a range of from 0 mm to 0.1 mm. On the other hand, it is apparent that the average R-tilt variation in Comparative Example 2 cannot be reduced compared with that in each of Examples 2 to 5 when the inner circumferential end portion of the disk substrate 2 was first pressed and the outer circumferential end portion of the disk substrate 2 was then pressed.

### THIRD EMBODIMENT

In order to prove an effect in the case where a laminating apparatus and method according to the invention were used, measurement was performed as described in the following Examples 6 to 8 and Comparative Example 3.

In Example 6, for lamination, the first pressure portion 24 pressed the outer circumferential end portion of the disk substrate 2 with bearing pressure of 8 kPa and then the second pressure portion 22 pressed the inner circumferential end portion of the disk substrate 2 with bearing pressure of 210 kPa.

In Example 7, for lamination, the first pressure portion 24 pressed the outer circumferential end portion of the disk substrate 2 with bearing pressure of 8 kPa and then the second pressure portion 22 pressed the inner circumferential end portion of the disk substrate 2 with bearing pressure of 330 kPa.

In Example 8, for lamination, the first pressure portion 24 pressed the outer circumferential end portion of the disk substrate 2 with bearing pressure of 8 kPa and then the second pressure portion 22 pressed the inner circumferential end portion of the disk substrate 2 with bearing pressure of 460 kPa.

On the other hand, in Comparative Example 3, for lamination, the second pressure portion 22 pressed the inner circumferential end portion of the disk substrate 2 with bearing pressure of 110 kPa and then the first pressure portion 24 pressed the outer circumferential end portion of the disk substrate 2 with bearing pressure of 38 kPa.

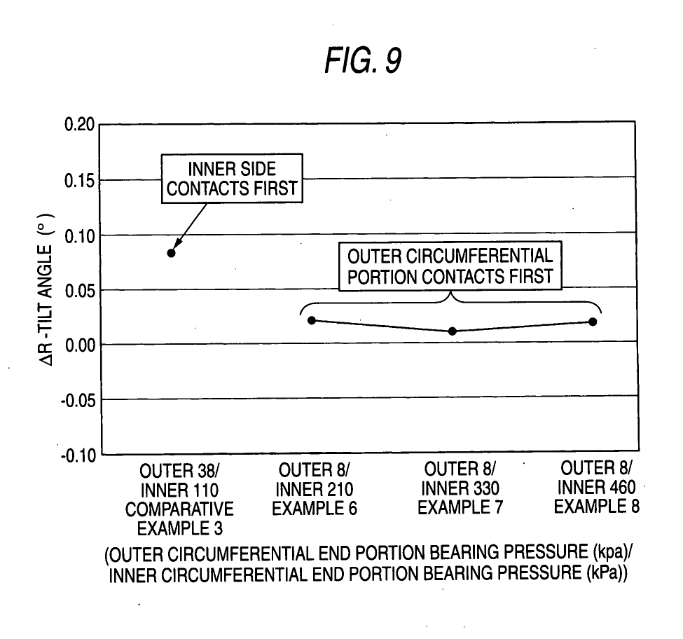

FIG. 9 shows an average R-tilt variation in each of Examples 6 to 8 and Comparative Example 3.

As shown in FIG. 9, it is apparent that the average R-tilt variation in each of Examples 6 to 8 can be reduced so that occurrence of the R-tilt can be suppressed. Incidentally, the average R-tilt variation does not change even when the internal pressure is increased to a value higher than necessary.

On the other hand, it is apparent that the average R-tilt variation in Comparative Example 3 is larger than that in each of Examples 6 to 8, and that Comparative Example 3 is small in the effect of suppressing occurrence of the R-tilt.

Incidentally, the invention is not limited to the embodiments. Suitable changes and modifications may be made on the invention.

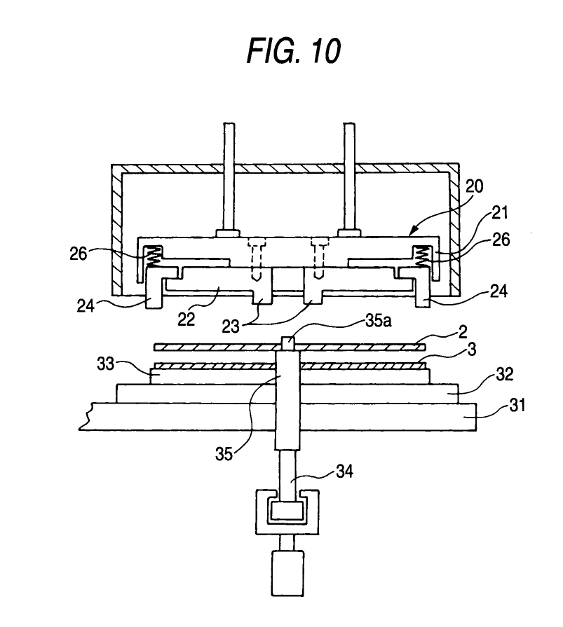

For example, as shown in FIG. 10, configuration may be made so that the second pressure portion 22 is fixed to the fixation member 21 of the pressure member 20. On this occasion, the bearing pressure of the inner circumferential end portion is adjusted by pressing force of the actuator attached above the pressure member 20 while the bearing pressure of the outer circumferential end portion is adjusted by urging force of the urging members (springs) 26. That is, the pressing force of the actuator is set to be equal to the sum of the pressure of the springs on the outer circumference and the pressure applied on the inner circumferential end portion.

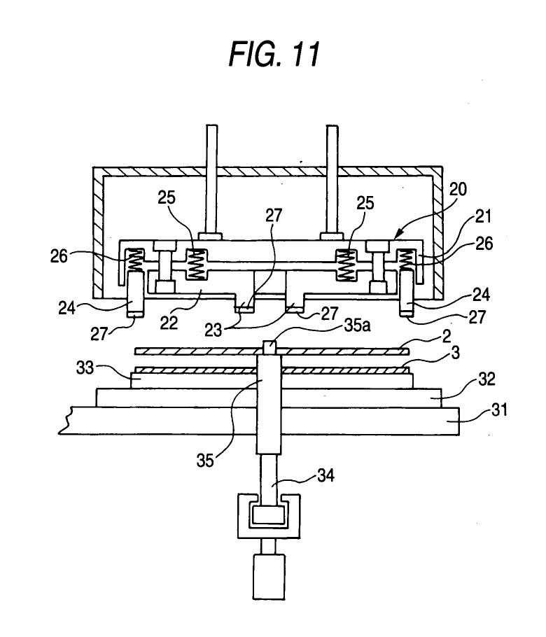

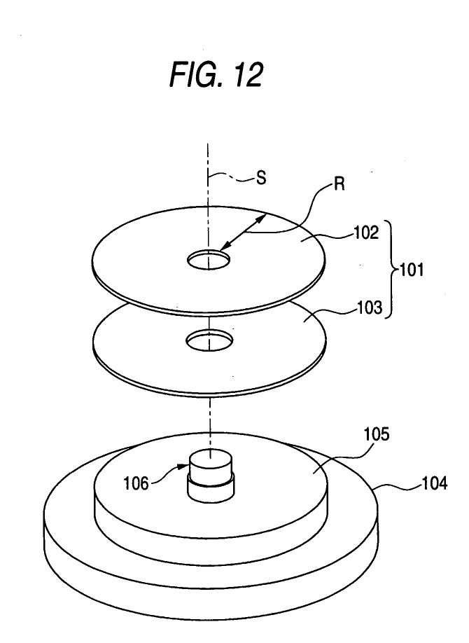

Alternatively, as shown in FIG. 11, configuration may be made so that elastic portions 27 made of a uniform elastic material (such as sponge, rubber, etc.) are attached to the lower end surface of the first pressure portion 24 for pressing the outer circumferential end portion and the lower end surface of the protrusion portion 23 of the second pressure portion 22 for pressing the inner circumferential end portion, respectively.

This application is based on Japanese Patent application JP 2004-374748, filed Dec. 24, 2004, the entire content of which is hereby incorporated by reference, the same as if set forth at length.

What is claimed is:

1. A laminating apparatus for laminating a cover layer onto a disk substrate, comprising a pressure member for pressing a surface of the disk substrate opposite to a surface on which the cover layer is to be laminated, wherein:
the pressure member includes a first pressure portion for pressing an outer circumferential end portion of the disk substrate, and a second pressure portion for pressing an inner circumferential end portion of the disk substrate; and
after the first pressure portion presses the outer circumferential end portion of the disk substrate, the second pressure portion presses the inner circumferential end portion of the disk substrate to thereby laminate the cover layer onto the disk substrate.

2. The laminating apparatus according to claim 1, wherein the second pressure portion presses the inner circumferential end portion after the first pressure portion presses the outer circumferential end portion in a place at least 0.1 mm ahead from the second pressure portion.

3. A laminating method for laminating a cover layer onto a disk substrate, comprising: operating a first pressure means to press an outer circumferential end portion of the disk substrate; and after the operating of the first pressure means, operating a second pressure means to press an inner circumferential end portion of the disk substrate so that a surface of the disk substrate opposite to a surface on which the cover layer is to be laminated is pressed to thereby laminate the cover layer onto the disk substrate.

4. The lamination method according to claim 3, wherein the second pressure means presses the inner circumferential end portion after the first pressure means presses the outer circumferential end portion in a place at least 0.1 mm ahead from the second pressure means.
